(19) United States
(12) Patent Application Publication
(10) Pub. No.: US 2023/0059937 A1
(43) Pub. Date: Feb. 23, 2023

(54) INFORMATION PROCESSING APPARATUS AND CONTROL METHOD THEREOF

(71) Applicant: CANON KABUSHIKI KAISHA, Tokyo (JP)

(72) Inventors: Yohei Horikawa, Tokyo (JP); Takeshi Ogawa, Tokyo (JP)

(21) Appl. No.: 17/880,777

(22) Filed: Aug. 4, 2022

(30) Foreign Application Priority Data
Aug. 20, 2021 (JP) 2021-135026

(51) Int. Cl. G06F 21/60

(52) U.S. Cl. CPC G06F 21/602

(57) ABSTRACT

An information processing apparatus comprises a non-volatile storage device and a volatile storage device. The information processing apparatus stores encrypted data in the non-volatile storage device and stores information used to decrypt the encrypted data in the volatile storage device.

### BACKGROUND OF THE INVENTION

### Field of the Invention

The present invention relates to an information processing apparatus and, a control method thereof, and particularly relates to data management technology.

### Description of the Related Art

In a known computing device, a volatile storage device such as DRAM and a non-volatile storage device such as EEPROM are selectively used depending on the application. For example, information required when starting up a device and information repeatedly used like device settings are stored in the non-volatile storage device. The program being executed and variables therefor, data being processed, and other temporarily used information are stored in the volatile storage device.

The information stored in the non-volatile storage device remains stored there unless purposely deleted. For this reason, methods for protecting confidential information stored in a non-volatile storage device have been proposed. As described in Japanese Patent Laid-Open No. 2015-90682, with an image forming apparatus that uses a non-volatile storage device as a main storage device, when a shutdown instruction is detected, the data stored in the non-volatile storage device is deleted.

With the method described in Japanese Patent Laid-Open No. 2015-90682, in cases in which a shutdown instruction is not detected, such as a case in which the power supply to the image forming apparatus is forcibly cut, the data stored in the non-volatile storage device may be read out by a third party.

### SUMMARY OF THE INVENTION

The present invention was made in light of the technological problem described above. An aspect of the present invention is directed at providing an information processing apparatus capable of more reliably protecting data stored in a non-volatile storage device and a control method thereof.

According to an aspect of the present invention, there is provided an information processing apparatus comprising: one or more processors that execute a program stored in a memory and thereby function as: an encrypting unit configured to encrypt data; and a storing unit configured to store data encrypted by the encrypting unit into a non-volatile storage device, and a volatile storage device that stores information used to decrypt data encrypted by the encrypting unit.

According to another aspect of the present invention, there is provided a control method of an information processing apparatus comprising: encrypting data; writing the encrypted data into a non-volatile storage device; and writing information used to decrypt the encrypted data into a volatile storage device.

According to a further aspect of the present invention, there is provided a non-transitory computer-readable storage medium storing a program for causing a computer to function as an information processing apparatus comprising: an encrypting unit configured to encrypt data; a storing unit configured to store data encrypted by the encrypting unit into a non-volatile storage device; and a volatile storage device that stores information used to decrypt data encrypted by the encrypting unit.

Further features of the present invention will become apparent from the following description of exemplary embodiments (with reference to the attached drawings).

### BRIEF DESCRIPTION OF THE DRAWINGS

FIG. 1 is a block diagram illustrating an example of the functional configuration of a digital camera 100 according to a first embodiment.

FIG. 2 is a diagram illustrating an example of a memory map of a non-volatile storage unit 112.

FIG. 3 is a diagram illustrating an example of the functional configuration of a key generation unit 110.

FIG. 4 is a diagram illustrating an example of the functional configuration of an encryption processing unit 108.

FIG. 5 is a timing chart relating to the encryption operations according to the first embodiment.

FIG. 6 is a timing chart relating to the encryption operations according to the first embodiment.

FIG. 7 is a diagram illustrating another example of a memory map of the non-volatile storage unit 112 according to a modified example of the first embodiment.

FIG. 8 is a diagram illustrating an example of the functional configuration of a key generation unit according to a modified example of the first embodiment.

FIG. 9 is a block diagram illustrating an example of the functional configuration of a digital camera 900 according to a second embodiment.

FIG. 10 is a diagram illustrating an example of the functional configuration of a key generation unit 910.

FIG. 11 is a flowchart relating to the operation of the digital camera 900 according to the second embodiment.

### DESCRIPTION OF THE EMBODIMENTS

Embodiments will be described in detail below with reference to the attached drawings. Note that the invention according to the scope of the claims are not limited by the embodiments described below. A plurality of advantages of the embodiments are given. However, all of the plurality of advantages are not required for the invention. Also, the plurality of advantages may be combined in a discretionary manner. Furthermore, in the attached drawings, the same or equivalent components are denoted with the same reference number, and redundant descriptions will be omitted.

Note that hereinafter, the present invention is described with respect to an embodiment in which the present invention is applied to a digital camera as an example of an information processing apparatus. However, the present invention is not required to have an image capture function and may be implemented with a typical electronic device. Examples of such an electronic device include video cameras, computer devices (personal computers, tablet computers, media players, PDAs, and the like), mobile phones, smartphones, game consoles, robots, drones, and drive recorder. These are examples, and the present invention can be implemented with other electronic devices.

### First Embodiment

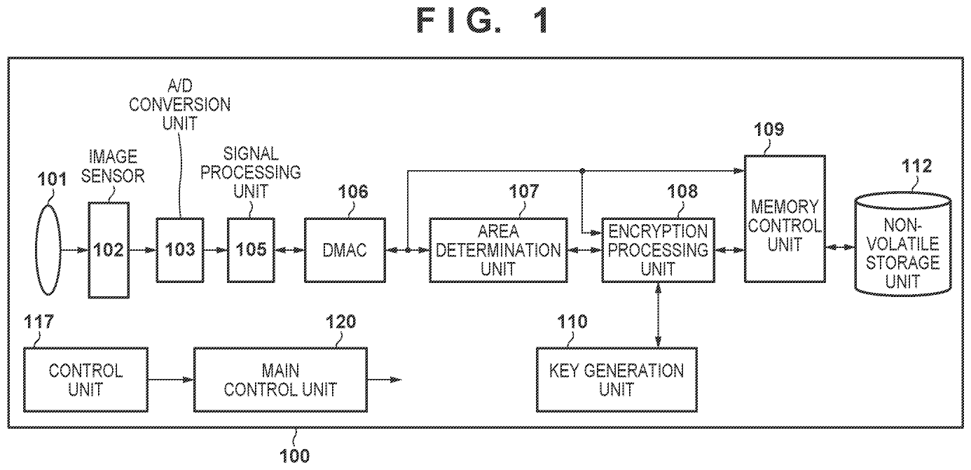

FIG. 1 is a block diagram illustrating an example of the configuration of a digital camera 100 according to the first embodiment of the present invention. The digital camera 100 uses a non-volatile storage unit 112 as a main storage device. Thus, the non-volatile storage unit 112 provides the function of a ROM for storing programs, various settings, GUI data, and the like and the function of a RAM for storing temporary data, such as intermediate data and programs being executed and variables therefor. However, when the power supply of the digital camera 100 is turned off, the temporary data remains stored in the non-volatile storage unit 112 without being immediately deleted. The non-volatile storage unit 112 can be implemented by a non-volatile semiconductor memory, such as a solid state drive (SSD) or a magnetoresistive random access memory (MRAM), but as long as the device can be used as a main storage device, it is not limited thereto. The non-volatile storage unit 112 will be described in detail below.

An imaging optical system 101 includes an optical lens group including a movable lens such as a focusing lens, a shutter, a diaphragm, and the like. The imaging optical system 101 forms an optical image on an imaging surface of an image sensor 102. A main control unit 120 controls the operations of the movable lens, the shutter, and the diaphragm of the imaging optical system 101. Note that configuration may be such that the imaging optical system 101 does not include a shutter or a diaphragm.

The image sensor 102 is a CMOS image sensor with a color filter array in which primary colors are arranged according to Bayer pattern. In the image sensor 102, a plurality of pixels are arranged in a two-dimensional array. A photoelectric conversion element (a photodiode) is formed in each pixel and generates charges corresponding to an amount of incident light during an exposure period. Because millions to tens of millions of pixels are formed in the image sensor 102, there may be pixels that do not operate normally (defective pixels). An output of a defective pixel cannot be used as it is. Therefore, the output is corrected by a defective pixel correction process that is performed by a signal processing unit 105 described below.

The signal read out from each pixel of the image sensor 102 (an analog image signal) is converted into a digital image signal (image data) by an A/D conversion unit 103. The A/D conversion unit 103 may apply noise reduction processing, amplification processing, and the like to the analog image signal before A/D conversion. The image data output by the A/D conversion unit 103 is supplied to the signal processing unit 105.

The signal processing unit 105 applies predetermined image processing to the image data output from the A/D conversion unit 103 and generates a signal or image data, obtains and/or generates various types of information, and the like. The signal processing unit 105 may be, for example, a dedicated hardware such as an application-specific integrated circuit (ASIC) designed to realize a specific function or may be configured to realize a specific function via a programmable processor such as a digital signal processor (DSP) executing a software.

Herein, the image processing applied by the signal processing unit 105 includes preprocessing, color interpolation processing, correction processing, detection processing, data modification processing, evaluation value calculation processing, special effects processing, and the like. Pre-processing includes the defective pixel correction process described above.

The color interpolation processing is processing for interpolating values of color components not obtained when shooting, and is also referred to as demosaicing processing or synchronization processing. Correction processing includes white balance adjustment, gradation correction (gamma processing), processing for correcting the effects of optical aberration or vignetting of the imaging optical system 101, processing for correcting color, and the like.

The detection processing includes processing for detecting a feature area (for example, a face area or a human body area) or movement thereof, processing for recognizing a person, and the like. The data modification processing includes combining processing, scaling processing, encoding and decoding processing, header information generation processing, and the like.

The evaluation value calculation processing includes processing for generating signals or evaluation values that are used in automatic focus detection (AF), processing for calculating evaluation values that are used in automatic exposure control (AE), and the like. Special effects processing includes processing for adding blurring, changing color tone, relighting processing, and the like. Note that these are examples of the image processing that can be applied by the signal processing unit 105, and are not intended to limit the image processing applied by the signal processing unit 105.

The signal processing unit 105 can execute image processing on image data for one frame for each area obtained by dividing the image data into predetermined processing units. This allows the amount of buffer memory in the signal processing unit 105 and/or the capability of the signal processing unit 105 to be reduced and thereby reducing power consumption.

In a case in which the image processing is executed for each area, the signal processing unit 105 stores the image data supplied from the A/D conversion unit 103 in the non-volatile storage unit 112. Thereafter, the signal processing unit 105 reads out the processing unit amount of image data from the non-volatile storage unit 112, applies image processing to the image data, and then stores the processed data in the non-volatile storage unit 112. Note that in the process of executing the image processing on one area, intermediate data can be stored in and read from the non-volatile storage unit 112 one or more times. By repeatedly executing the image processing on a processing unit amount of image data, the signal processing unit 105 executes the image processing on the image data for one frame.

The signal processing unit 105 accesses the non-volatile storage unit 112 via a DMAC 106 and a memory control unit 109. The signal processing unit 105 can, for example, apply the image processing for each processing unit obtained by dividing the image data of one pixel line in the horizontal direction, for example.

The signal processing unit 105 may apply the image processing without dividing the image data of one frame. In this case also, in the process of executing the processing, intermediate data can be stored in and read from the non-volatile storage unit 112 one or more times.

The signal processing unit 105 generates image data for recording and/or image data for display by applying the image processing. These pieces of image data can be recorded on a memory card or the like, output to an external apparatus, or displayed on a display apparatus of the digital camera 100. In addition, the evaluation values generated by the signal processing unit 105 are supplied to the main control unit 120 and used for AF and AE processing in the main control unit 120.

In a case in which the generated data is stored in the non-volatile storage unit 112, the signal processing unit 105 determines whether or not encryption of the generated data is required according to the type of the data. In addition, the signal processing unit 105 knows address spaces of a confidential area and a normal area (described below) that are set to the non-volatile storage unit 112. In a case in which the signal processing unit 105 has generated data to be stored in the non-volatile storage unit 112, the signal processing unit 105 sets, to the DMAC 106, information required for DMA transfer, such as a transfer source address of the buffer memory in the signal processing unit 105 and a transfer destination address in the non-volatile storage unit 112. When the data to be transferred (stored) has been prepared in the buffer memory, the signal processing unit 105 outputs a DMA request to the DMAC 106.

Note that when the signal processing unit 105 reads out data from the non-volatile storage unit 112, the signal processing unit 105 also sets, to the DMAC 106, the information required for DMA transfer and then outputs a DMA request to the DMAC 106. In this case, the transfer source is an address of the non-volatile storage unit 112, and the transfer destination is an address of the buffer memory in the signal processing unit 105.

The DMAC 106 transfers data from the signal processing unit 105 to the non-volatile storage unit 112 in accordance with the settings made by the signal processing unit 105. The DMAC 106 outputs control signals relating to data transfer to an area determination unit 107, an encryption processing unit 108, and the memory control unit 109.

Specifically, the DMAC 106 outputs a REQ signal, an ADR signal, a WRITE_EN signal, and a D signal as control signals relating to reading and writing (storing) data from/to the non-volatile storage unit 112. The REQ signal is a request signal for reading or writing data from/to the non-volatile storage unit 112. The ADR signal is a signal indicating the addresses for which read/write is requested. The WRITE_EN signal is a signal indicating whether a read or write is requested. The D signal is a signal indicating the data to be written.

Upon receiving the REQ signal, the memory control unit 109 outputs the ACK signal to the DMAC 106. The memory control unit 109 also outputs the Q signal indicating the data read out from the non-volatile storage unit 112 to the encryption processing unit 108 and the DMAC 106.

The area determination unit 107 determines whether or not the area for which access is requested by a read/write request is a predetermined confidential area on the basis of the REQ signal and the ADR signal that are output signals of the DMAC 106. The area determination unit 107 can make the determination using the information relating to the address of the confidential area set to the non-volatile storage unit 112 and the address indicated by the ADR signal. The information relating to the address of the confidential area can be stored, for example, in the area determination unit 107. The area determination unit 107 outputs an area determination signal of high-level to the encryption processing unit 108 in a case in which it is determined that the area to which the DMAC 106 requests access is the confidential area and an area determination signal of low-level to the encryption processing unit 108 in a case in which it is determined that the area is not the confidential area.

Note that the area determination unit 107 may determine whether or not the storage destination of the data is the confidential area on the basis of the transfer destination address set by the signal processing unit 105 to the DMAC 106, instead of on the basis of the output signal of the DMAC 106.

Alternatively, the area determination unit 107 may receive a notification from the signal processing unit 105 as to whether or not the data to be stored is data that should be stored in the confidential area.

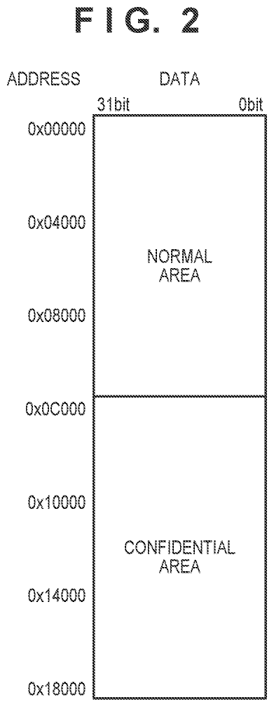

FIG. 2 is a diagram illustrating an example of an area setting in the non-volatile storage unit 112. The vertical axis represents addresses in bytes of the non-volatile storage unit 112, and the horizontal axis represents a 32-bit data space. As an example, it is assumed that the capacity of the non-volatile storage unit 112 is 96 KB, the address space from 0x000 to 0xBFFF is set as the normal area and the address space from 0xC000 to 0x17FFF is set as the confidential area.

Because encryption is not required for the data to be stored into the normal area, the normal area can be referred to as a non-encrypted area. On the other hand, because encryption is required for data to be stored in the confidential area, the confidential area can be referred to as an encrypted area. Note that at least one confidential area is to be set to the non-volatile storage unit 112 whereas the normal area is not essential. The entire area of the non-volatile storage unit 112 may be set as the confidential area. The setting of the confidential area for the non-volatile storage unit 112 is determined by the manufacturer of the digital camera 100. In addition, information that can identify the confidential area in the non-volatile storage unit 112 is stored, for example, in a memory of the signal processing unit 105 and/or the area determination unit 107. The information that can identify the confidential area can take various forms such as, for example, a combination of the start address and the end address, a combination of the start address and the size, and information indicating a predetermined setting pattern between the confidential area and the normal area.

In addition, it is assumed that it is predetermined which data (information) is to be stored in the confidential area. For example, information that the manufacturer of the digital camera 100 wants to keep secret is an example of data to be stored in the confidential area (confidential information). For example, intermediate data generated by the signal processing unit 105 during an application of the image processing to the image data is data that should be stored in the confidential area because the intermediate data reflects a proprietary technique of the manufacturer.

The main control unit 120 includes a CPU (processor), ROM, and RAM. The main control unit 120 controls units of the digital camera 100 by reading a program stored in the ROM into the RAM and executing it to realize the functions of the digital camera 100. Although not illustrated in FIG. 1, the main control unit 120 is communicatively connected to each of the other blocks. The ROM is a rewritable non-volatile memory, for example, and stores a program executable by the CPU of the main control unit 120, setting values, GUI data, and the like. RAM is used to load a program to be executed by the CPU of the main control unit 120 and to store necessary values during execution of the program.

Note that the main control unit 120 may read and execute a program stored in the non-volatile storage unit 112. The main control unit 120 may also store a program stored in the non-volatile storage unit 112 in another area of the non-volatile storage unit 112 and then execute the program.

The main control unit 120 performs AF processing and AE processing using the evaluation values obtained from the signal processing unit 105. In AF processing, the main control unit 120 adjusts the position of the focusing lens of the imaging optical system 101 so that a focus detection area to be in focus. In AE processing, the main control unit 120 determines exposure conditions for the image sensor 102 (an f-number, an exposure time, and a shooting sensitivity), and then adjusts the aperture of the imaging optical system 101 and the settings of the image sensor 102.

A control unit 117 is a generic term for an input device (buttons, switches, dials, and the like) that is provided for the user to input various instructions to the digital camera 100. Each of the input devices constituting the control unit 117 has a name corresponding to the function assigned to it. For example, the control unit 117 includes a release switch, a moving image recording switch, a shooting mode selection dial for selecting a shooting mode, a menu button, a directional key, an enter key, and the like. The release switch is a switch for recording a still image, and the main control unit 120 recognizes a half-pressed state of the release switch as an image capture preparation instruction and a fully-pressed state of the release switch as an image capture start instruction. In addition, the main control unit 120 recognizes a press of the moving image recording switch during an image capture standby state as a moving image recording start instruction and a press of the moving image recording switch during the recording of a moving image as a recording stop instruction. Note that the functions assigned to the same input device may be variable. Also, the input device may be software buttons or keys using a touch display. The control unit 117 may also include an input device compatible with non-contact input methods such as voice input and eye input.

A key generation unit 110 generates an encryption key to be used in the encryption processing unit 108 in response to an instruction from the main control unit 120. In this embodiment, it is assumed that the encrypted data can be decrypted using the encryption key used for the encryption. In a case in which decryption of the encrypted data uses information different from the encryption key used for the encryption (referred to as a decryption key), the key generation unit 110 generates the decryption key together with the encryption key as a set.

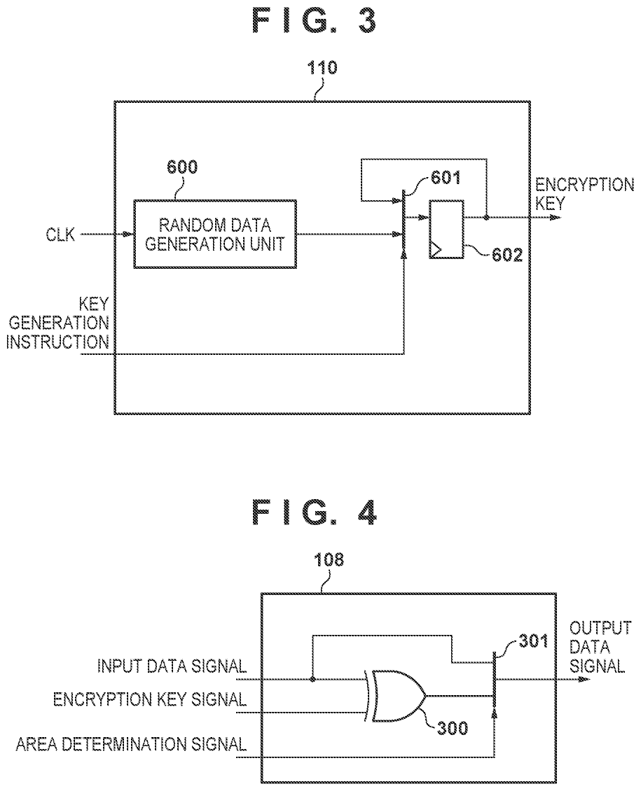

FIG. 3 is a circuit diagram illustrating an example of the configuration of the key generation unit 110. The key generation unit 110 includes a random data generation unit 600, a flip-flop 602, and a selector 601.

The random data generation unit 600 is a circuit that generates random data. The random data generation unit 600 generates new data every time a clock signal CLK is input. The clock signal CLK can be obtained, for example, from a signal generated by a clock generation circuit of the digital camera 100. The random data is multi-bit data (for example, 8-bit data, 24-bit data, 32-bit data, and the like) and is used as the encryption key. Note that instead of the random data itself, another piece of data obtained using random data may be generated as the encryption key.

Herein, random data refers a value that has no regularity and is unpredictable or difficult to predict.

The value should change at least every time it is generated and should not be a value that can be easily generated by a third party from unique data or other data held in the digital camera 100. The method of generating the random data is not particularly limited, but for example, the remainder when the current time is divided by a specific value can be generated as the random data.

The flip-flop 602 is an example of a volatile storage device that holds the encryption key. The flip-flop 602 holds its value as long as power is supplied and holds an input signal at a rising edge of the clock signal CLK. When the power of the digital camera 100 is turned off, the flip-flop 602 can no longer hold data, and thus the encryption key is deleted. Although a single flip-flop 602 is illustrated in FIG. 3, flip-flops of which the number is equal to the number of bits of random data are arranged in parallel to hold the encryption key as a whole, such that each flip-flop holds one bit of the random data. Another volatile storage device, such as SRAM, may be used instead of the flip-flop 602.

The selector 601 selects the output of the random data generation unit 600 when the key generation instruction is at a High level. The selector 601 selects the output of the flip-flop 602 when the key generation instruction is at Low level. Thus, the same random data (encryption key) is held in the flip-flop 602 while the key generation instruction is at Low level. When the key generation instruction becomes High level, the random data output by the random data generation unit 600 at that time is held in the flip-flop 602 at the rising edge of the clock signal CLK. In other words, when the key generation instruction becomes High level, the encryption key is updated.

The key generation instruction is supplied by the main control unit 120 to the key generation unit 110 at a predetermined timing. For example, the main control unit 120 sets the key generation instruction to a High level when the key generation unit 110 does not hold the encryption key, such as when the digital camera 100 starts up, thereby causing the volatile storage device of the key generation unit 110 to hold the encryption key. For example, the main control unit 120 may set the key generation instruction to a High level before image capture for the live view display is started, such as when the power of the digital camera 100 is turned from off to on or when the sleep mode of the digital camera 100 is released.

The main control unit 120 may also periodically update the encryption key. However, in this case, the data encrypted using the encryption key before the update and stored in the non-volatile storage unit 112 cannot be decrypted. For this reason, the encryption key may be updated only when there is no data stored in the confidential area of the non-volatile storage unit 112 or when the data stored in the confidential area is determined to be unnecessary. For example, the main control unit 120 may determine that intermediate data relating to a frame to which image processing has already been applied or data that has been stored for a predetermined period of time or longer are unnecessary.

For example, in a case in which the power supply is forcibly stopped, such as when the battery of the digital camera 100 is removed, the encryption key held in the key generation unit 110 will disappear. On the other hand, the data stored in the confidential area of the non-volatile storage unit 112 have been encrypted using the encryption key held by the key generation unit 110. Thus, even if the non-volatile storage unit 112 is removed from the digital camera 100 and analyzed, the data stored in the confidential area cannot be decrypted.

The encryption key held in the volatile storage device (the flip-flop 602) of the key generation unit 110 can be protected so that it cannot be referenced or read by anything other than the encryption processing unit 108 (i.e., by anything other than encryption means). This can further enhance the confidentiality of the data stored in the confidential area of the non-volatile storage unit 112.

Returning to FIG. 1, the encryption processing unit 108 applies the encryption processing using the encryption key generated by the key generation unit 110 to the D signal output by the DMAC 106 that is determined by the area determination unit 107 to be data to be stored in the confidential area. The encryption processing unit 108 outputs the encrypted data to the memory control unit 109.

The encryption processing unit 108 applies the encryption removal (decryption) processing using the encryption key generated by the key generation unit 110 to the Q signal output by the memory control unit 109 which is read out from the confidential area. The encryption processing unit 108 outputs the decrypted data to the memory control unit 109 or the DMAC 106.

FIG. 4 is a circuit diagram illustrating an example of the configuration of the encryption processing unit 108. The encryption processing unit 108 includes a logical exclusive OR (XOR) gate as an application unit 300 and a selector 301.

The encryption processing unit 108 performs encryption when the input data signal is a D signal (write data), and decryption when the input data signal is a Q signal (read data).

In the example illustrated in FIG. 4, by implementing the application unit 300 by an XOR gate to which the encryption key and input data are input, encryption and decryption can be realized in the same configuration, and the processing load in encryption and decryption can be reduced. In other words, the example illustrated is a configuration in which the encryption key is also used as the decryption key. Note that the encryption processing unit 108 using the XOR gate is just one example, and any encryption and decryption method using the encryption key can be applied.

The encryption of write data (D signal) is described below. Here, it is assumed that each input of the XOR gate is an 8-bit input and that the encryption key is also 8 bits.

The input data signal is supplied to one of the inputs of the XOR gate 300 in 8-bit units. Also, the 8-bit encryption key is also supplied from the key generation unit 110 to the other input of the XOR gate 300. Accordingly, the logical exclusive OR of the 8-bit input data signal and the encryption key is obtained as the encrypted data. Thereafter, the same encryption is applied to the input data signal every 8 bits.

The decryption of the read data (Q signal) is described below. Here also, it is assumed that each input of the XOR gate is an 8-bit input and that the encryption key is also 8 bits. If the encryption key used to encrypt the read data and the encryption key supplied from the key generation unit 110 are the same, the XOR operation between the read data and the encryption key corresponds to the decryption process.

Note that the image processing in the signal processing unit 105 may be performed in pixel units or block units. Thus, the encryption processing unit 108 may be configured to be capable of performing the encryption for each processing unit in image processing. For example, the encryption processing unit 108 may be configured to allow selection between encryption in pixel units and encryption in macroblock units.

The selector 301 outputs the output of the XOR gate 300 when the area determination signal is at a High level and outputs the input data signal when the area determination signal is at a Low level. Thus, the whole area can be divided into a confidential area and a normal area according to the address of the non-volatile storage unit 112, i.e., the main storage device.

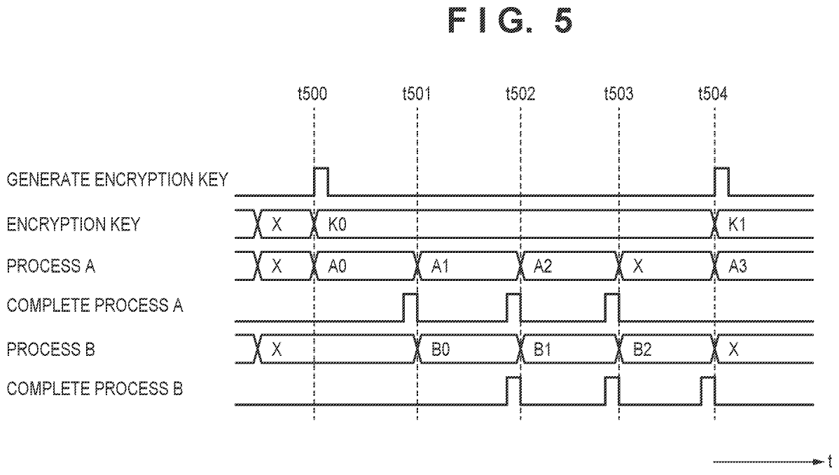

Next, referring to the timing chart illustrated in FIG. 5, the encryption key generation operation when the digital camera 100 is operating will be described. FIG. 5 illustrates the encryption operation when the signal processing unit 105 executes process A and process B, both of which reference the confidential area. Here, it is assumed that the data obtained in the process A is confidential data and the data obtained during the process B is not confidential data. In addition, it is also assumed that the process B uses the data obtained in the process A.

At time t500, the main control unit 120 sets the key generation instruction to High level to instruct the key generation unit 110 to generate an encryption key. In response to this, the key generation unit 110 generates and holds an encryption key K0.

Also, at time t500, the process A starts sub-process A0. The signal processing unit 105 writes the data obtained in the sub-process A0 to the confidential area of the non-volatile storage unit 112 via the DMAC 106. The data obtained in the sub-process A0 is encrypted using the encryption key K0.

At time t501, the process A completes the sub-process A0 and starts sub-process A1. The signal processing unit 105 writes the data obtained in the sub-process A1 to the confidential area of the non-volatile storage unit 112 via the DMAC 106. The data obtained in the sub-process A1 is encrypted using the encryption key K0. On the other hand, the process B starts sub-process B0 while reading the result of the sub-process A0 written in the confidential area. The data read out is decrypted using the encryption key K0. The signal processing unit 105 writes the data obtained in the sub-process B0 to the normal area of the non-volatile storage unit 112 via the DMAC 106.

At time t502, the process A completes the sub-process A1 and starts sub-process A2. The signal processing unit 105 writes the data obtained in the sub-process A2 to the confidential area of the non-volatile storage unit 112 via the DMAC 106. The data obtained in the sub-process A2 is encrypted using the encryption key K0. On the other hand, the process B starts sub-process B1 while reading the result of the sub-process A1 written in the confidential area. The data read out is decrypted using the encryption key K0. The signal processing unit 105 writes the data obtained in the sub-process B1 to the normal area of the non-volatile storage unit 112 via the DMAC 106.

At time t503, the process A completes the sub-process A2. In this manner, the process A is completed. On the other hand, the process B starts sub-process B2 while reading the result of the sub-process A2 written in the confidential area. The data read out is decrypted using the encryption key K0. The signal processing unit 105 writes the data obtained in the sub-process B2 to the normal area of the non-volatile storage unit 112 via the DMAC 106.

At time t504, the process B completes the sub-process B2. In this manner, the process B is completed. With the completion of the process B, the data written in the confidential area during the process A is no longer required. Thus, there is no problem even if the encryption key as the decryption key is updated (in other words, there is no problem even if the data written in the confidential area during the process A cannot be decrypted). However, if the encryption key is updated before the completion of the process B, the process B cannot be correctly performed since the data written in the confidential area during the process A cannot be decrypted. At time t504, the main control unit 120 sets the key generation instruction to High level to instruct the key generation unit 110 to generate an encryption key. In response to this, the key generation unit 110 generates and holds an encryption key K1. The encryption key is updated accordingly.

Also, at time t504, the process A starts sub-process A3. The signal processing unit 105 writes the data obtained in the sub-process A3 to the confidential area of the non-volatile storage unit 112 via the DMAC 106. The data obtained in the sub-process A3 is encrypted using the encryption key K1. Thereafter, the same operations as t501 to t503 are performed using the encryption key K1 until the completion of sub-process B5. Then, the signal processing unit 105 continues to execute the processes A and B while periodically updating the encryption key until there is no more image data to be processed.

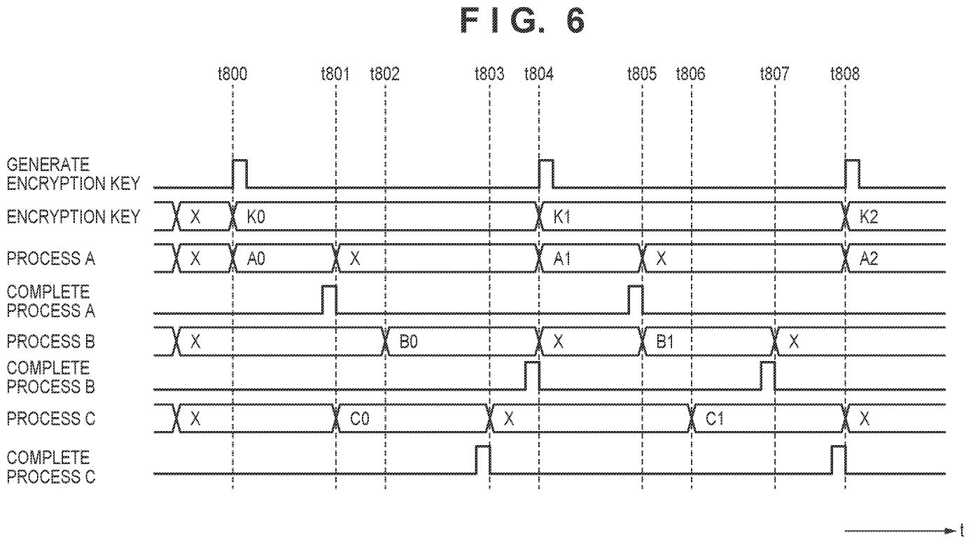

Next, referring to the timing chart illustrated in FIG. 6, the encryption operation when process C, in addition to the process B, references the data obtained during the process A, will be described.

At time t800, the main control unit 120 sets the key generation instruction to High level to instruct the key generation unit 110 to generate an encryption key. In response to this, the key generation unit 110 generates and holds an encryption key K0.

Also, at time t800, the process A starts sub-process A0. The signal processing unit 105 writes the data obtained in the sub-process A0 to the confidential area of the non-volatile storage unit 112 via the DMAC 106. The data obtained in the sub-process A0 is encrypted using the encryption key K0.

At time t801, the process A completes the sub-process A0. On the other hand, the process C starts sub-process C0 while reading the result of the sub-process A0 written in the confidential area. The data read out is decrypted using the encryption key K0. The signal processing unit 105 writes the data obtained in the sub-process C0 to the normal area of the non-volatile storage unit 112 via the DMAC 106.

At time t802, the process B starts sub-process B0 while reading the result of the sub-process A0 written in the confidential area. The data read out is decrypted using the encryption key K0. The signal processing unit 105 writes the data obtained in the sub-process B0 to the normal area of the non-volatile storage unit 112 via the DMAC 106. Between time t802 and t803, the sub-processes C0 and B0 are executed in parallel.

At time t803, the process C completes the sub-process C0.

At time t804, the process B completes the sub-process B0.

At time t804, if the main control unit 120 detects that the sub-processes B0 and C0, which reference the sub-process A0, are completed, the main control unit 120 updates the encryption key. In other words, the main control unit 120 sets the key generation instruction to High level to instruct the key generation unit 110 to generate an encryption key. In response to this, the key generation unit 110 generates and holds the encryption key K1.

Also, at time t804, the process A starts sub-process A1. The signal processing unit 105 writes the data obtained in the sub-process A1 to the confidential area of the non-volatile storage unit 112 via the DMAC 106. The data obtained in the sub-process A1 is encrypted using the encryption key K1.

At time t805, the process A completes the sub-process A1. On the other hand, the process B starts sub-process B1 while reading the result of the sub-process A1 written in the confidential area. The data read out is decrypted using the encryption key K1. The signal processing unit 105 writes the data obtained in the sub-process B1 to the normal area of the non-volatile storage unit 112 via the DMAC 106.

At time t806, the process C starts sub-process Cl while reading the result of the sub-process A1 written in the confidential area. The data read out is decrypted using the encryption key K1. The signal processing unit 105 writes the data obtained in the sub-process Cl to the normal area of the non-volatile storage unit 112 via the DMAC 106. Between time t806 and t807, the sub-processes Cl and B1 are executed in parallel.

At time t807, the process B completes the sub-process B1.

At time t808, the process C completes the sub-process Cl.

At time t808, if the main control unit 120 detects that the sub-processes B1 and Cl, which reference the sub-process A1, are completed, the main control unit 120 updates the encryption key. In other words, the main control unit 120 sets the key generation instruction to High level to instruct the key generation unit 110 to generate an encryption key. In response to this, the key generation unit 110 generates and holds the encryption key K2.

Also, at time t808, the process A starts sub-process A2. The signal processing unit 105 writes the data obtained in the sub-process A2 to the confidential area of the non-volatile storage unit 112 via the DMAC 106. The data obtained in the sub-process A2 is encrypted using the encryption key K2.

Thereafter, the processes A, B, and C execute the sub-processes in the same manner. When sub-processes Bx and Cx (x=0, 1, 2, . . . ), which reference the result of sub-process Ax stored in the confidential area, are completed, the main control unit 120 updates the encryption key.

In this embodiment, since there is one confidential area, the data obtained by the sub-process A0 and stored in the confidential area is overwritten when the data obtained by the sub-process A1 is stored and thus becomes unavailable. Thus, the encryption key is updated after detecting that all the processes that reference the data written in the confidential area have been completed. This allows the encryption key to be updated without affecting the operation of the process that references the data encrypted using the encryption key before the update. In addition, by updating the encryption key, the confidentiality of the data recorded in the confidential area can be further enhanced.

Note that herein, an example has been described in which the encryption key is updated every time new data is written in the confidential area. However, it is also possible to update the encryption key in a longer cycle. Also, the encryption key does not necessarily have to be updated. By holding the encryption key in the volatile storage device, even if the encryption key is not updated, the confidentiality of the data written in the confidential area of the non-volatile storage unit 112 is maintained in a case in which the power supply is forcibly cut off.

The encryption key may be updated when a specific event occurs. Such an event may include, but is not limited to, when the buffer memory for image data is emptied during continuous shooting and when the operation mode is changed.

Note that according to this embodiment, when the encryption key is updated, the data encrypted using the encryption key before the update and then written in the confidential area can no longer be decrypted. Thus, by updating or deleting the encryption key instead of deleting the data written in the confidential area, the same confidentiality effect as the deletion of data can be obtained without actually performing the delete operation of the non-volatile storage unit 112.

As explained above, according to this embodiment, the encryption key used to encrypt the data stored in the non-volatile storage device is held in the volatile storage device. Thus, if the power supply is forcibly cut, for example, by the removal of the battery in a battery-powered device, the encryption key disappears, preventing a third party from decrypting the encrypted data stored in the non-volatile storage device. Accordingly, the confidentiality of intermediate data and other data generated during a process in a device that uses a non-volatile storage device as its main storage device can be maintained.

### Modified Examples

In the above-described embodiment, a single confidential area is set to the non-volatile storage unit 112 and only one encryption key is used. However, multiple confidential areas may be set to the non-volatile storage unit 112. In addition, the encryption key can be generated and held for each one of the confidential areas.

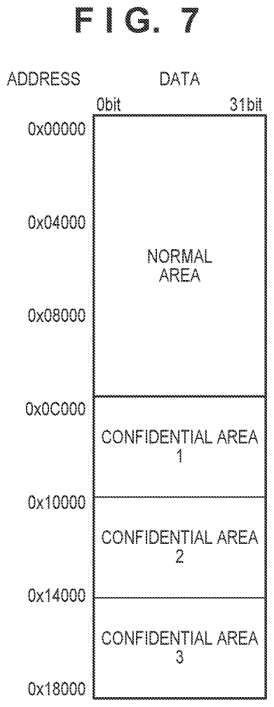

FIG. 7 illustrates an example of a memory map of the non-volatile storage unit 112 to which three confidential areas are set, with the vertical axis and the horizontal axis being the same as those illustrated in FIG. 2.

In the example, addresses from 0x00000 to 0x0FFFF are designated as a confidential area 1, addresses from 0x10000 to 0x13FFF as a confidential area 2, and addresses from 0x14000 to 0x17FFF as a confidential area 3. Note that in another example, even-numbered addresses may be set as the confidential area 1 and odd-numbered addresses may be set as the confidential area 2. In this case, the confidential areas are switched every byte. Basically, there are no limitations on how to set the confidential areas as long as the areas can be divided regularly by addresses.

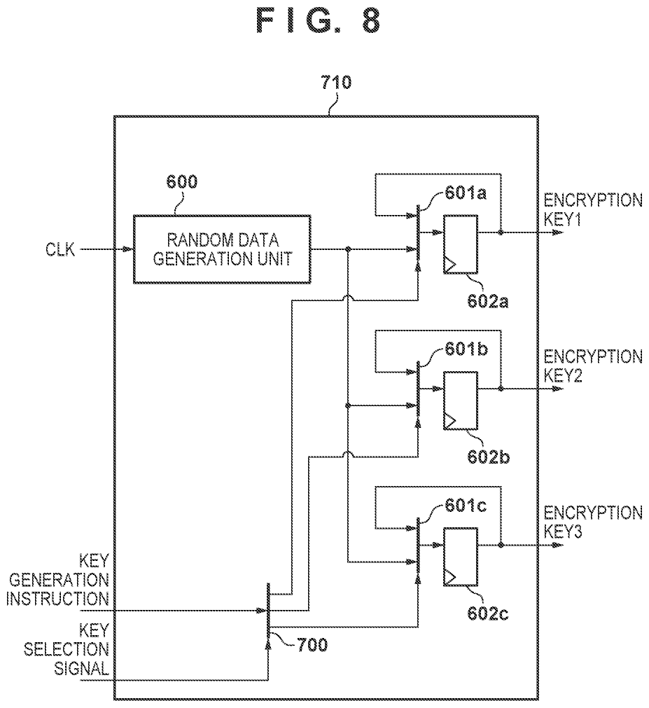

FIG. 8 is a diagram illustrating an example of the configuration of a key generation unit 710 for a case in which the confidential areas 1 to 3 each use a different encryption key. In FIG. 8, components that are the same as those in FIG. 3 are given the same reference numerals as used in FIG. 3.

In the key generation unit 710, flip-flops 602a to 602c and selectors 601a to 601c are respectively provided for each confidential area to hold the encryption keys. In the key generation unit 710, a key selection unit 700 for distributing the random data output by the random data generation unit 600 to the flip-flops 602a to 602c is also provided.

The key selection unit 700 outputs, for example, a key generation instruction to one of the selectors 601a to 601c according to the value of the selection signal. The key selection unit 700, for example, outputs the key generation instruction to the selector 601a if the selection signal is 0, to the selector 601b if the selection signal is 1, and to the selector 601c if the selection signal is 2. This allows the random data (encryption keys 1 to 3) generated by the random data generation unit 600 at different timings to be held in the flip-flops 602a to 602c according to the value of the selection signal.

The encryption processing unit 108 determines which of the confidential areas 1 to 3 is accessed on the basis of the ADR signal output by the DMAC 106. Then, the encryption processing unit 108 can acquire the encryption key corresponding to the determined confidential area from the key generation unit 710 and perform encryption or decryption.

### Second Embodiment

In the first embodiment, the protection of confidential data can be achieved even in a case in which power supply is forcibly cut by information (an encryption key) required for the decryption of the confidential data stored in the non-volatile storage device being held in the volatile storage device. However, in a case in which the power supply is cut via a normal operation of the apparatus, the confidential data also cannot be decrypted.

For example, the digital camera 100 described in the first embodiment has a configuration in which, when the remaining amount of the battery goes below a threshold, the main control unit 120 turns off the power of the digital camera 100. In this case, a process being executed when the power is turned off is suspended. In a case in which this process uses the confidential data stored in the non-volatile storage unit 112, the process cannot be continued (restarted) due to the encryption key disappearing when the power is turned off.

An information processing apparatus according to the present embodiment is configured in a manner such that confidential data stored in the non-volatile storage device used as the main storage device can be protected and a process suspended by the power supply being cut via a normal operation of the apparatus can be continued (restarted).

Specifically, the information processing apparatus according to the present embodiment stores (saves) information (an encryption key) required for the decryption of confidential data stored in the non-volatile storage device in an external apparatus or acquires the information from an external apparatus. This allows the confidential data stored in the non-volatile storage device to be decrypted even in a case in which the encryption key held by the volatile storage device disappears due to the cutting of power.

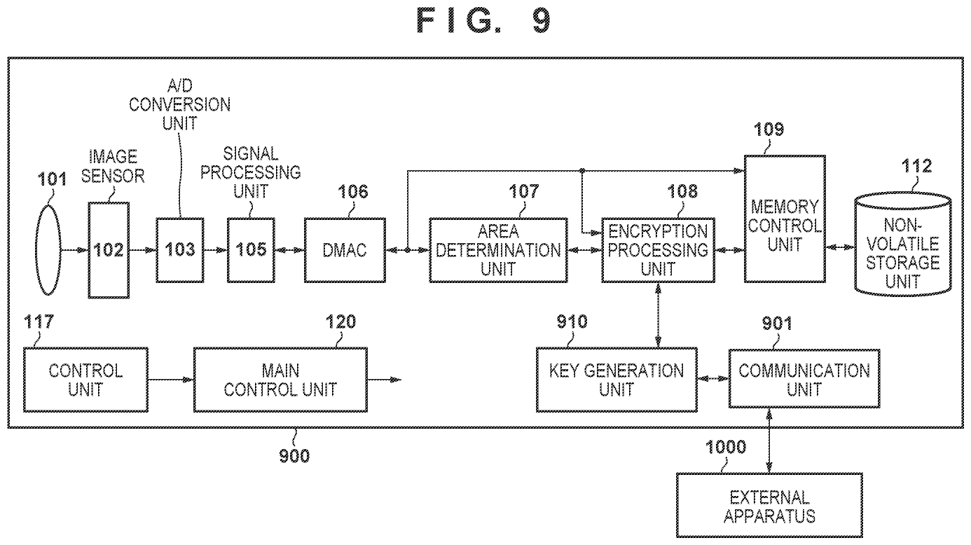

FIG. 9 is a block diagram illustrating an example of the configuration of a digital camera 900 representing an example of an information processing apparatus according to the second embodiment. In FIG. 9, components that are the same as in the digital camera 100 according to the first embodiment are given the same reference sign as in FIG. 1 and descriptions thereof are omitted.

A communication unit 901 communicates with an external apparatus 1000 via wired or wireless communication. The communication unit 901 supports one or more communication standards. Thus, the communication unit 901 is provided with a communication interface compatible with the supported communication standard. The external apparatus 1000 may be an apparatus that directly communicates with the communication unit 901 or may be an apparatus that communicates via another device (for example, an access point, a server, or the like). Also, the external apparatus 1000 may be an information processing apparatus, such as a computer or a smart phone, or may be a storage device, such as an SSD, an NAS, or a cloud storage (service).

For example, consider a case in which, as a normal operation of the digital camera 900, a process using the encrypted data stored in the non-volatile storage unit 112 is suspended and the power supply is cut (the power is turned off). In this case, the main control unit 120 (transmitting unit) transmits (stores) the encryption key from the volatile storage device (flip-flop 602) to the external apparatus 1000 before the power supply is cut. Also, the main control unit 120 stores information indicating that the encryption key has been saved in the external apparatus 1000 and information required for restarting the suspended process (for example, the type of the process and information indicating where to restart the process from) in the non-volatile storage unit 112. Note that the information required for restarting the suspended process need to be stored in the non-volatile storage unit 112 and may be transmitted (stored) to the external apparatus 1000 with the encryption key. The main control unit 120 cuts the power supply after the completion of the transmission (storage) of the encryption key and the various types of information.

Note that the information required for acquisition of the encryption key and the like stored in the external apparatus 1000 can be stored in advance in the non-volatile storage unit 112 depending on the type of the external apparatus 1000 and the communication method of the external apparatus 1000. For example, in a case in which the external apparatus 1000 is a directly connected storage device, the information may be the stored file name, stored address, or other similar information. Also, in a case in which the external apparatus 1000 is a communication apparatus such as a server, the information may be information required for communication (for example, a login name, a password, and other information used for encrypted communication) and information for identifying the encryption key (file name, URL, and the like). These are merely example, and information including the encryption key may be stored in the external apparatus 1000, and discretionary information required for acquisition of the information stored in the external apparatus 1000 from the external apparatus 1000 may be stored in the non-volatile storage unit 112.

The main control unit 120 (acquiring unit) acquires the encryption key and the like from the external apparatus 1000 when the situation becomes one in which the suspended process can be restarted, such as when the power off state is released. This allows the confidential data to be decrypted and the suspended process to be restarted. In a case in which the power supply was forcibly cut not by an operation of the digital camera 900 but by the battery being removed or the like, because the encryption key is not saved in the external apparatus, the encryption key stored in the non-volatile storage unit 112 is protected as in the first embodiment.

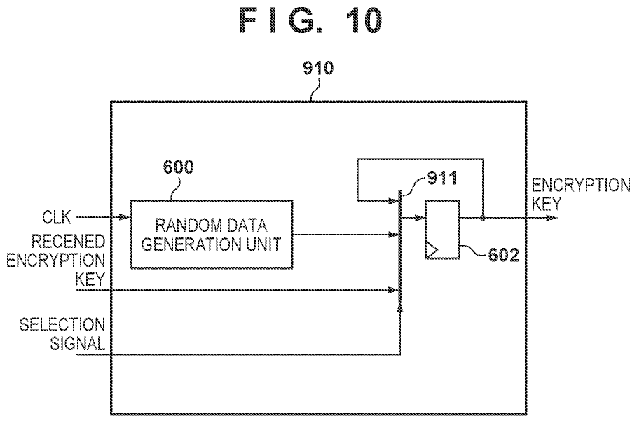

To achieve this action, a key generation unit 910 is configured to hold the encryption key acquired from the external apparatus 1000 in the flip-flop 602. FIG. 10 is a circuit diagram illustrating an example of the configuration of the key generation unit 910. Components that are the same as in the key generation unit 110 according to the first embodiment are given the same reference signs as in FIG. 3 and descriptions thereof are omitted.

A selector 911 outputs one from among random data output by the random data generation unit 600, output data of the flip-flop 602, or an encryption key input via the communication unit 901 to the flip-flop 602 according to the selection signal. The selection signal is supplied by the main control unit 120 to the selector 911.

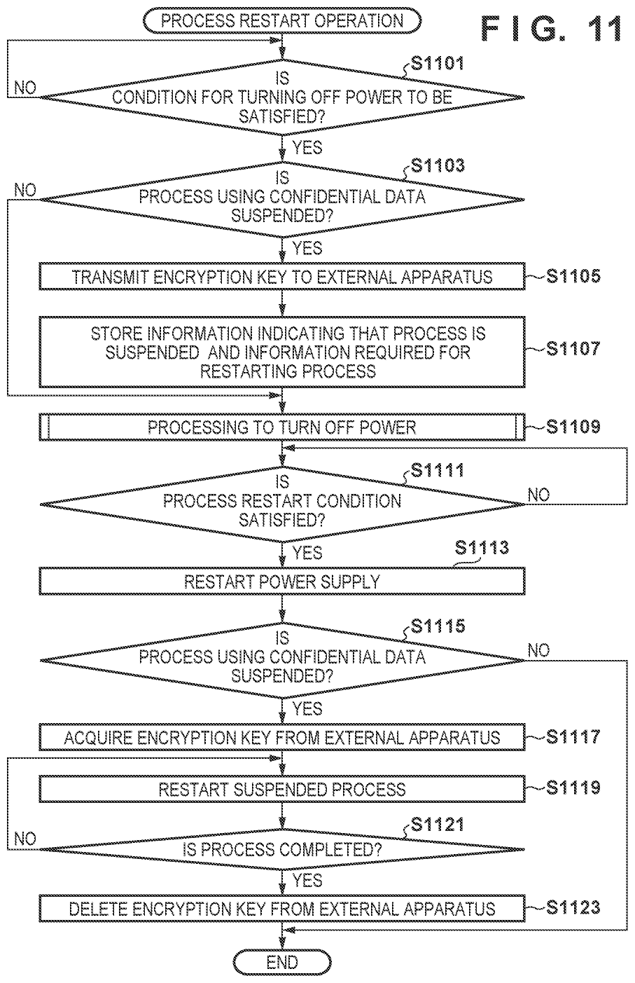

Next, using the flowchart illustrated in FIG. 11, the operations of the main control unit 120 before and after power supply is cut in the present embodiment will be described. The processing described herein can be executed at a discretionary timing when the digital camera 900 is in a powered on state.

In step S1101, the main control unit 120 determines whether or not a predetermined condition for turning off the power without a user operation is satisfied. This condition may be the battery remaining amount being below a threshold, for example. In a case in which the condition is determined to be satisfied, the main control unit 120 executes step S1103, and in a case in which the condition is determined to not be satisfied, the main control unit 120 repeatedly executes step S1101.

In step S1103, the main control unit 120 determines whether or not a process using encrypted data (confidential data) stored in a confidential area of the non-volatile storage unit 112 will be suspended. In a case in which it is determined that a process using confidential data will be suspended, the main control unit 120 executes step S1105, and in a case in which it is determined otherwise, the main control unit 120 executes step S1109.

In step S1105, the main control unit 120 transmits or stores the encryption key held in the flip-flop 602 to/in the external apparatus 1000 via the communication unit 901. Note that if a communication connection with the external apparatus 1000 is not established, the main control unit 120 establishes a connection with the external apparatus 1000 at this time.

In step S1107, the main control unit 120 stores information indicating that a process using confidential data has been suspended and information required for restarting the suspended process in a normal area of the non-volatile storage unit 112. The information need not be encrypted, and information stored in a normal area of the non-volatile storage unit 112, such as information specific to the digital camera 900, may be used and encrypted. Note that instead of storing the information in the non-volatile storage unit 112, the main control unit 120 may transmit or store the information in a similar manner to the encryption key or together with the encryption key in the external apparatus 1000.

In step S1109, the main control unit 120 executes predetermined processing to turn off the power. Accordingly, the digital camera 900 transitions to a power off state, and the encryption key held by the flip-flop 602 disappears.

In step S1111, the main control unit 120 determines whether or not a process restart condition has been satisfied. The process restart condition may be the battery remaining amount being equal to or greater than a threshold, for example. Alternatively, the condition may be a power on instruction being detected via the control unit 117 and the battery remaining amount being equal to or greater than a threshold. The battery remaining amount threshold herein may be a value greater than the threshold used for the power off condition. In a case in which the process restart condition is determined to be satisfied, the main control unit 120 executes step S1113, and in a case in which the condition is determined to not be satisfied, the main control unit 120 repeatedly executes step S1111.

In step S1113, the main control unit 120 starts power supply into the digital camera 900. Note that in a case in which the satisfied process restart condition is a condition not based on a user operation (for example, a power on instruction), the range of power supply may be less than a case in which the condition is based on a user operation. For example, in a case in which a condition not based on a user operation is satisfied, power may only be supplied to components required for internal processing and power is not supplied to other components, such as the image sensor, the display apparatus, the imaging optical system, and other components relating to image capture and display.

In step S1115, the main control unit 120 references the non-volatile storage unit 112 and determines whether or not the process using confidential data is in a suspended state on the basis of a value or whether or not there is information indicating that a process using confidential data has been suspended. Alternatively, the main control unit 120 may determine whether or not a process using confidential data is in a suspended state on the basis of other information such as whether or not an encryption key is stored in an external apparatus. In a case in which it is determined that a process using confidential data is in a suspended state, the main control unit 120 executes step S1117, and in a case in which it is determined otherwise, the main control unit 120 ends the processing of the present flowchart. Note that in a case in which, in step S1111, it is determined that a condition based on a user operation is satisfied, the processing of the present flowchart may end and normal start up processing may be executed.

In step S1117, the main control unit 120 acquires the encryption key from the external apparatus 1000 via the communication unit 901 on the basis of the information stored in the non-volatile storage unit 112. The main control unit 120 causes the acquired encryption key to be held by the flip-flop 602 of the key generation unit 910.

In step S1119, the main control unit 120 restarts the process suspended before the power was turned off on the basis of the information stored in the non-volatile storage unit 112. In restarting the process, the main control unit 120 uses the encryption key held by the flip-flop 602 of the key generation unit 910 to decrypt and use the confidential data stored in the non-volatile storage unit 112.

In step S1121, the main control unit 120 determines whether or not the restarted process has completed. When it is determined to be completed, step S1123 is executed, otherwise step S1119 is repeatedly executed.

In step S1123, the main control unit 120 deletes the encryption key held in the flip-flop 602 and the encryption key stored in the external apparatus 1000. In a case in which information indicating that a process using confidential data has been suspended, information required for restarting the suspended process, and the like are stored in the external apparatus 1000, the main control unit 120 deletes this information.

In this manner, according to the present embodiment, in a case in which a process using the confidential data stored in the non-volatile storage unit 112 is suspended when the power state transitions to a power off state via a normal operation, the power off state is transitioned to after the encryption key is stored in the external apparatus 1000. Thus, protection of confidential data can be achieved by holding the encryption key in the volatile storage device, and the suspended process can be continued (restarted) using the encryption key stored in the external apparatus.

### Modified Examples

The encryption key may be generated by the external apparatus 1000 and not the key generation unit 910. In this case, the main control unit 120 causes the encryption key acquired from the external apparatus 1000 to be held by the flip-flop 602. Also, in a case in which a process using confidential data is suspended when the power state transitions to a power off state via a normal operation, the main control unit 120 stores information indicating that a process using confidential data has been suspended and information required for restarting the suspended process in the non-volatile storage unit 112. The encryption key does not need to be stored (saved) in the external apparatus 1000. As necessary, the main control unit 120 may request for the external apparatus 1000 to hold the encryption key before the power state transitions to a power off state. In a case in which the process can be restarted, the main control unit 120 can acquire the encryption key from the external apparatus 1000 and can restart the process as described using FIG. 11.

Also, in a case in which the restarted process is completed, in step S1123, the main control unit 120 may request the external apparatus 1000 to update the encryption key.

According to the present modified example, a random data generation unit, a selector, and the like are not required.

### OTHER EMBODIMENTS

Note that in the embodiments described above, it is assumed that the encryption method uses the same information (encryption key) for both encryption and decryption of data. However, the essence of the present invention is to hold in the volatile storage device the information required for decryption of the encryption that has been applied to the data stored in the confidential area of the non-volatile storage unit 112. Thus, in a case in which an encryption method using different information (also referred to as a decryption key) to the encryption key is used for decryption of the data stored in the confidential area, the decryption key is held in the volatile storage device (flip-flop 602) in the key generation unit 110 or 910. In this case, the encryption key may or may not be held in the volatile storage device (flip-flop 602) of the key generation unit 110 or 910. In the case of using a decryption key, the key generation unit 110 or 910 may be configured to also generate a decryption key when generating (including updating) an encryption key.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-135026, filed Aug. 20, 2021, which is hereby incorporated by reference herein in its entirety.

What is claimed is:

1. An information processing apparatus comprising:
one or more processors that execute a program stored in a memory and thereby function as:
an encrypting unit configured to encrypt data; and
a storing unit configured to store data encrypted by the encrypting unit into a non-volatile storage device, and
a volatile storage device that stores information used to decrypt data encrypted by the encrypting unit.

2. The information processing apparatus according to claim 1, wherein the one or more processors further function as a generating unit configured to, if the information does not exist in the volatile storage device, generate the information and store the information into the volatile storage device.

3. The information processing apparatus according to claim 2, wherein the generating unit generates the information and store the information into the volatile storage device when the information processing apparatus starts up and/or when an operation mode of the information processing apparatus changes.

4. The information processing apparatus according to claim 2, wherein the information generated by the generating unit varies each time when generated.

5. The information processing apparatus according to claim 1, wherein the non-volatile storage device having a plurality of areas, and
wherein the encrypting unit encrypts data stored in an area set as an area for storing encrypted data, from among the plurality of areas.

6. The information processing apparatus according to claim 5, wherein if two or more areas are set for storing encrypted data, the volatile storage device stores the information for each of the two or more areas.

7. The information processing apparatus according to claim 1, instead of deleting data encrypted by the encrypting unit, from among data stored in the non-volatile storage device, the information processing apparatus updates information used to decrypt the data or deletes the information used to decrypt the data from the volatile storage device.

8. The information processing apparatus according to claim 1, wherein the encrypting unit decrypts encrypted data read out from the non-volatile storage device using the information stored in the volatile storage device, and
wherein the information stored in the volatile storage device is protected so that the information can only be referenced or read by the encrypting unit.

9. The information processing apparatus according to claim 1, wherein the information stored in the volatile storage device is information that the encrypting unit also uses to encrypt data.

10. The information processing apparatus according to claim 1, wherein data to be encrypted by the encrypting unit is data temporarily stored in the non-volatile storage device.

11. The information processing apparatus according to claim 1, wherein the non-volatile storage device is used as a main storage device of the information processing apparatus.

12. A control method of an information processing apparatus comprising:
encrypting data;
writing the encrypted data into a non-volatile storage device; and
writing information used to decrypt the encrypted data into a volatile storage device.

13. A non-transitory computer-readable storage medium storing a program for causing a computer to function as an information processing apparatus comprising:
an encrypting unit configured to encrypt data;
a storing unit configured to store data encrypted by the encrypting unit into a non-volatile storage device; and
a volatile storage device that stores information used to decrypt data encrypted by the encrypting unit.
